(19) United States
(12) Patent Application Publication
(10) Pub. No.: US 2026/0206748 A1
(43) Pub. Date: Jul. 23, 2026

(54) ANTIBACTERIAL AND ANTIVIRAL HOME DECORATION BOARD RELEASING NEGATIVE OXYGEN IONS AND PREPARATION METHOD THEREOF

(71) Applicant: JAPAN AOZU GROUP (ASIA) LIMITED, HONG KONG (CN)

(72) Inventor: ZHENG XUE, HONG KONG (CN)

(21) Appl. No.: 19/567,603

(22) Filed: Mar. 16, 2026

Related U.S. Application Data
(63) Continuation of application No. PCT/CN2025/115006, filed on Aug. 15, 2025.

(30) Foreign Application Priority Data
Aug. 15, 2024 (HK) 22024095595.9

(51) Int. Cl. A01N 25/34; A01N 25/08; A01N 59/00; A01P 1/00

(52) U.S. Cl. CPC A01N 25/34; A01N 25/08; A01N 59/00; A01P 1/00

(57) ABSTRACT

The present application relates to the technical field of composite materials, and particularly to antibacterial and antiviral furniture releasing negative oxygen ions, a home decoration board, and a preparation method thereof. The home decoration board is prepared with polyolefin resin and wood fiber as main raw materials, with the addition of nano-silicon sheets, a lubricant, an antioxidant, a flame retardant, a coupling agent, and an inorganic reinforcing filler. The addition of nano-silicon sheets effectively improves the antiviral and antibacterial properties of the home decoration board while enabling the release of a large number of negative oxygen ions. The flame retardant improves flame resistance, while the inorganic reinforcing filler improves the mechanical property of the home decoration board. The coupling agent ensures compatibility and dispersion uniformity among the various components.

### CROSS-REFERENCES TO RELATED APPLICATIONS

The present application is a continuation application of International Application No. PCT/CN2025/115006, filed on Aug. 15, 2025, which claims priority to Hong Kong Original Grant Standard Patent Application No. 22024095595.9, filed on Aug. 15, 2024, with the Hong Kong Intellectual Property Department, the entire contents of which are incorporated into the present application by reference.

### TECHNICAL FIELD

The present application relates to the technical field of composite materials, and particularly relates to antibacterial and antiviral furniture releasing negative oxygen ions, a home decoration board, and a preparation method thereof.

### BACKGROUND ART

Traditional home decoration boards and furniture are mostly prepared from wooden materials. However, the wooden materials have low strength and poor water resistance and corrosion resistance, are easily invaded by bacteria and viruses, and have a short service life.

With the development of the plastics industry, wood-plastic composite materials prepared from polyolefin resin and wood fiber have been widely used. Chinese patent CN103342786B discloses a preparation method of a bagasse/polyethylene composite material. In the bagasse/polyethylene composite material, bagasse is linked to polyethylene through chemical bonds, resulting in high tensile strength and impact strength, but the antiviral property and antibacterial property need to be improved; Chinese patent CN107987548B discloses a high-strength wood-plastic composite material, which has excellent tensile strength and bending strength, but the antiviral property and antibacterial property also need to be improved.

### SUMMARY

In view of the shortcomings of the prior art, the present application provides antibacterial and antiviral furniture releasing negative oxygen ions, a home decoration board, and a preparation method thereof to solve the problems that the antiviral property and antibacterial property of wood-plastic composite materials for home decoration need to be improved in the prior art.

To achieve the foregoing objective, the present application adopts the following technical solutions:

A preparation method of an antibacterial and antiviral home decoration board releasing negative oxygen ions, comprising the following steps:
step 1: weighing dried raw materials: polyolefin resin, wood fiber, nano-silicon sheets, a lubricant, an antioxidant, a flame retardant, a coupling agent, and inorganic reinforcing filler;
step 2: stirring and mixing the wood fiber, the nano-silicon sheets, the lubricant, the antioxidant, the flame retardant, the coupling agent, and the inorganic reinforcing filler to obtain a mixed material;
step 3: adding the polyolefin resin into the mixed material, mixing uniformly, and performing melt blending and extrusion granulation to obtain composite particles;
step 4: extruding the composite particles in a molten state through an extruder, and performing calendering molding to obtain the antibacterial and antiviral home decoration board releasing negative oxygen ions.

Preferably, in the step 1, the dried raw materials comprise, in parts by weight, 20-30 parts of polyolefin resin, 35-50 parts of wood fiber, 5-10 parts of nano-silicon sheets, 3-5 parts of lubricant, 0.5-1 part of antioxidant, 1-3 parts of flame retardant, 0.5-1.5 parts of coupling agent, and 3-5 parts of inorganic reinforcing filler.

Preferably, the polyolefin resin comprises polyethylene.

Preferably, the polyethylene comprises high-density polyethylene.

Preferably, the lubricant comprises stearate, the antioxidant comprises pentaerythritol tetrakis [β-(3,5-di-tert-butyl-4-hydroxyphenyl) propionate], the flame retardant comprises 9,10-dihydro-9-oxa-10-phosphaphenanthrene 10-oxide, the coupling agent comprises a silane coupling agent, and the inorganic reinforcing filler comprises glass fiber.

Preferably, the stearate comprises any one of zinc stearate and calcium stearate, and the silane coupling agent comprises any one of γ-(methacryloyloxy) propyltrimethoxysilane, γ-aminopropyltriethoxysilane, and γ-glycidoxypropyltrimethoxysilane.

Preferably, in the step 3, a temperature of melt blending is 170-190° C.

Preferably, in the step 4, a barrel temperature of the extruder is 170-190° C., and a die head temperature is 190-200° C.

The present application further discloses an antibacterial and antiviral home decoration board releasing negative oxygen ions prepared by the above-mentioned preparation method of an antibacterial and antiviral home decoration board releasing negative oxygen ions.

Antibacterial and antiviral furniture releasing negative oxygen ions prepared from the above-mentioned antibacterial and antiviral home decoration board releasing negative oxygen ions is provided.

Compared with the prior art, the present application has the beneficial effects as follows:
in the present application, the home decoration board is synthesized using the polyolefin resin and the wood fiber as the main raw materials, and by adding the nano-silicon sheets, the lubricant, the antioxidant, the flame retardant, the coupling agent, and the inorganic reinforcing filler, various properties of the home decoration board are achieved,
wherein the nano-silicon sheets are selected from natural inorganic bentonite or attapulgite, which are detached layer by layer into sheets using a delamination technology, and are rich in negative charges, the negative charges exposed to the outside will form a strong adsorption force such that positively charged bacteria, viruses, or odors are adsorbed to their surfaces, and the adoption of the mechanism of using the natural silicon sheets to adsorb harmful molecules and resist adhesion can achieve the special effects of environmental purification, bacterial resistance and mildew prevention, dust removal and deodorization, and ultraviolet resistance, and can effectively prevent the breeding of germs and purify environmental quality; by the addition of the nano-silicon sheets, the antiviral property and antibacterial property of the home decoration board can be effectively improved, and a large number of negative oxygen ions can be released;
by the addition of the flame retardant, the flame retardant property of the home decoration board can be effectively improved; by the addition of the inorganic reinforcing filler, the mechanical property of the home decoration board can be effectively improved; by the addition of the coupling agent, the compatibility and dispersion uniformity among various components can be effectively improved.

### BRIEF DESCRIPTION OF THE DRAWINGS

FIG. 1 is a flow chart of a preparation process of an antibacterial and antiviral home decoration board releasing negative oxygen ions in the present application;

FIG. 2 is a bar chart of negative oxygen ion release property test results of home decoration boards prepared in Embodiments 1-6 and Comparative Examples 1-4 of the present application;

FIG. 3 is a bar chart of flame retardant property test results of the home decoration boards prepared in Embodiments 1-6 and Comparative Examples 1-4 of the present application; and

FIG. 4 is a bar chart of mechanical property test results of the home decoration boards prepared in Embodiments 1-6 and Comparative Examples 1-4 of the present application.

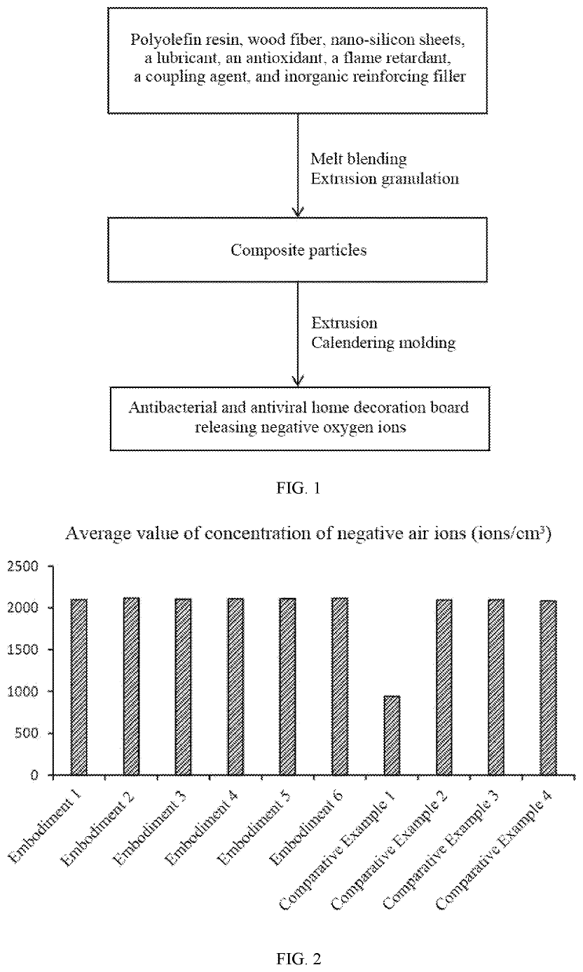

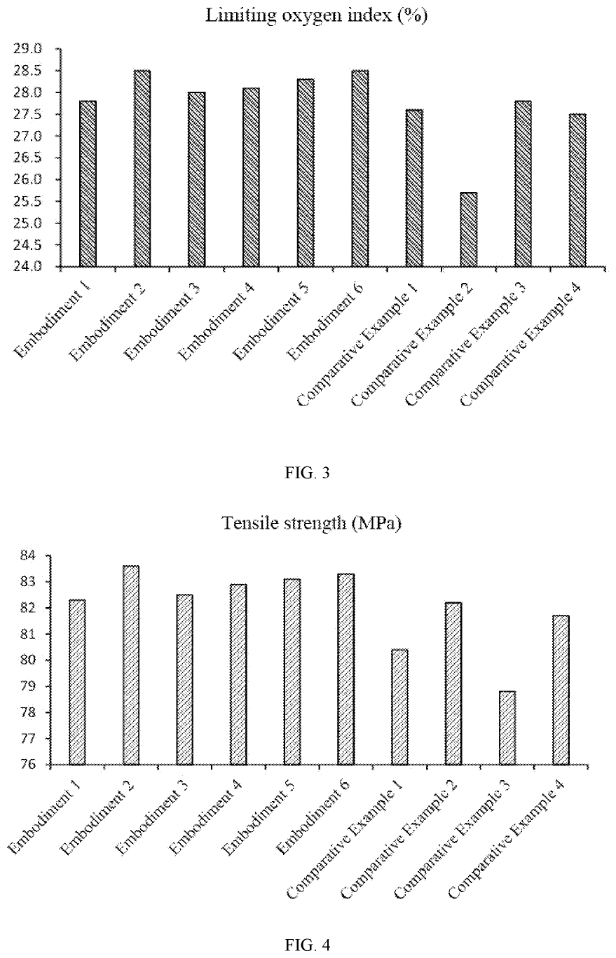

### DETAILED DESCRIPTION

The technical solutions in the embodiments of the present application are clearly and completely described below in conjunction with the embodiments of the present application. Obviously, the described embodiments are only some of the embodiments of the present application, rather than all of the embodiments. Based on the embodiments in the present application, all other embodiments obtained by those of ordinary skill in the art without creative efforts fall within the scope of protection of the present application.

### Embodiment 1

This embodiment discloses a preparation method of an antibacterial and antiviral home decoration board releasing negative oxygen ions, comprising the following steps:
step 1: weighing dried raw materials: 20 parts of high-density polyethylene, 35 parts of wood fiber, 5 parts of nano-silicon sheets, 3 parts of lubricant (zinc stearate), 0.5 parts of antioxidant (pentaerythritol tetrakis [β-(3,5-di-tert-butyl-4-hydroxyphenyl) propionate]), 1 part of flame retardant (9,10-dihydro-9-oxa-10-phosphaphenanthrene 10-oxide), 0.5 parts of coupling agent (γ-(methacryloyloxy) propyltrimethoxysilane), and 3 parts of inorganic reinforcing filler (glass fiber);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 170° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 170° C., and a die head temperature is 190° C.

### Embodiment 2

This embodiment discloses a preparation method of an antibacterial and antiviral home decoration board releasing negative oxygen ions, comprising the following steps:
step 1: weighing dried raw materials: 30 parts of high-density polyethylene, 50 parts of wood fiber, 10 parts of nano-silicon sheets, 5 parts of lubricant (calcium stearate), 1 part of antioxidant (pentaerythritol tetrakis [β-(3,5-di-tert-butyl-4-hydroxyphenyl) propionate]), 3 parts of flame retardant (9,10-dihydro-9-oxa-10-phosphaphenanthrene 10-oxide), 1.5 parts of coupling agent (γ-aminopropyltriethoxysilane), and 5 parts of inorganic reinforcing filler (glass fiber);
step 2: stirring and mixing the wood fiber, the nano-silicon sheets, the lubricant (calcium stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), the coupling agent (γ-aminopropyltriethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 190° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 190° C., and a die head temperature is 200° C.

### Embodiment 3

This embodiment discloses a preparation method of an antibacterial and antiviral home decoration board releasing negative oxygen ions, comprising the following steps:
step 1: weighing dried raw materials: 22 parts of high-density polyethylene, 38 parts of wood fiber, 6 parts of nano-silicon sheets, 3.4 parts of lubricant (zinc stearate), 0.6 parts of antioxidant (pentaerythritol tetrakis [β-(3,5-di-tert-butyl-4-hydroxyphenyl) propionate]), 1.4 parts of flame retardant (9,10-dihydro-9-oxa-10-phosphaphenanthrene 10-oxide), 0.7 parts of coupling agent (γ-glycidoxypropyltrimethoxysilane), and 3.4 parts of inorganic reinforcing filler (glass fiber);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), the coupling agent (γ-glycidoxypropyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 180° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 180° C., and a die head temperature is 195° C.

### Embodiment 4

This embodiment discloses a preparation method of an antibacterial and antiviral home decoration board releasing negative oxygen ions, comprising the following steps:
step 1: weighing dried raw materials: 24 parts of high-density polyethylene, 41 parts of wood fiber, 7 parts of nano-silicon sheets, 3.8 parts of lubricant (zinc stearate), 0.7 parts of antioxidant (pentaerythritol tetrakis [β-(3,5-di-tert-butyl-4-hydroxyphenyl) propionate]), 1.8 parts of flame retardant (9,10-dihydro-9-oxa-10-phosphaphenanthrene 10-oxide), 0.9 parts of coupling agent (γ-(methacryloyloxy) propyltrimethoxysilane), and 3.8 parts of inorganic reinforcing filler (glass fiber);
step 2: stirring and mixing the wood fiber, the nano-silicon sheets, the lubricant (zinc (pentaerythritol tetrakis [β-(3,5-di-tert-butyl-4-stearate), the antioxidant hydroxyphenyl) propionate]), the flame retardant (9,10-dihydro-9-oxa-10-phosphaphenanthrene 10-oxide), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 190° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 190° C., and a die head temperature is 200° C.

### Embodiment 5

This embodiment discloses a preparation method of an antibacterial and antiviral home decoration board releasing negative oxygen ions, comprising the following steps:
step 1: weighing dried raw materials: 26 parts of high-density polyethylene, 44 parts of wood fiber, 8 parts of nano-silicon sheets, 4.2 parts of lubricant (zinc stearate), 0.8 parts of antioxidant (pentaerythritol tetrakis [β-(3,5-di-tert-butyl-4-hydroxyphenyl) propionate]), 2.2 parts of flame retardant (9,10-dihydro-9-oxa-10-phosphaphenanthrene 10-oxide), 1.1 parts of coupling agent (γ-(methacryloyloxy) propyltrimethoxysilane), and 4.2 parts of inorganic reinforcing filler (glass fiber);
step 2: stirring and mixing the wood fiber, the nano-silicon sheets, the lubricant (zinc stearate), the antioxidant tetrakis [β-(3,5-di-tert-butyl-4-(pentaerythritol hydroxyphenyl) propionate]), the flame retardant (9,10-dihydro-9-oxa-10-phosphaphenanthrene 10-oxide), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 190° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 190° C., and a die head temperature is 200° C.

### Embodiment 6

This embodiment discloses a preparation method of an antibacterial and antiviral home decoration board releasing negative oxygen ions, comprising the following steps:
step 1: weighing dried raw materials: 28 parts of high-density polyethylene, 47 parts of wood fiber, 9 parts of nano-silicon sheets, 4.6 parts of lubricant (zinc stearate), 0.9 parts of antioxidant (pentaerythritol tetrakis [β-(3,5-di-tert-butyl-4-hydroxyphenyl) propionate]), 2.6 parts of flame retardant (9,10-dihydro-9-oxa-10-phosphaphenanthrene 10-oxide), 1.3 parts of coupling agent (γ-(methacryloyloxy) propyltrimethoxysilane), and 4.6 parts of inorganic reinforcing filler (glass fiber);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 190° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 190° C., and a die head temperature is 200° C.

### Comparative Example 1

This comparative example discloses a preparation method of an antibacterial and antiviral home decoration board releasing negative oxygen ions, comprising the following steps:
step 1: weighing dried raw materials: 20 parts of high-density polyethylene, 35 parts of wood fiber, 3 parts of lubricant (zinc stearate), 0.5 parts of antioxidant (pentaerythritol tetrakis [β-(3,5-di-tert-butyl-4-hydroxyphenyl) propionate]), 1 part of flame retardant (9,10-dihydro-9-oxa-10-phosphaphenanthrene 10-oxide), 0.5 parts of coupling agent (γ-(methacryloyloxy) propyltrimethoxysilane), and 3 parts of inorganic reinforcing filler (glass fiber);
step 2: stirring and mixing the wood fiber, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 170° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 170° C., and a die head temperature is 190° C.

### Comparative Example 2

This comparative example discloses a preparation method of an antibacterial and antiviral home decoration board releasing negative oxygen ions, comprising the following steps:
step 1: weighing dried raw materials: 20 parts of high-density polyethylene, 35 parts of wood fiber, 5 parts of nano-silicon sheets, 3 parts of lubricant (zinc stearate), 0.5 parts of antioxidant (pentaerythritol tetrakis [β-(3,5-di-tert-butyl-4-hydroxyphenyl) propionate]), 0.5 parts of coupling agent (γ-(methacryloyloxy) propyltrimethoxysilane), and 3 parts of inorganic reinforcing filler (glass fiber);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the coupling agent (γ-(methacryloyloxy) propyltrimethoxysilane), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 170° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 170° C., and a die head temperature is 190° C.

### Comparative Example 3

This comparative example discloses a preparation method of an antibacterial and antiviral home decoration board releasing negative oxygen ions, comprising the following steps:
step 1: weighing dried raw materials: 20 parts of high-density polyethylene, 35 parts of wood fiber, 5 parts of nano-silicon sheets, 3 parts of lubricant (zinc stearate), 0.5 parts of antioxidant (pentaerythritol tetrakis [β-(3,5-di-tert-butyl-4-hydroxyphenyl) propionate]), 1 part of flame retardant (9,10-dihydro-9-oxa-10-phosphaphenanthrene 10-oxide), and 0.5 parts of coupling agent (γ-(methacryloyloxy) propyltrimethoxysilane);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), and the coupling agent (γ-(methacryloyloxy) propyltrimethoxysilane) at a speed of 150 r/min for 30 min to obtain a mixed material;
step 3: adding the high-density polyethylene into the mixed material, mixing uniformly at a speed of 150 r/min, then performing melt blending at a temperature of 170° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 170° C., and a die head temperature is 190° C.

### Comparative Example 4

This comparative example discloses a preparation method of an antibacterial and antiviral home decoration board releasing negative oxygen ions, comprising the following steps:
step 1: weighing dried raw materials: 20 parts of high-density polyethylene, 35 parts of wood fiber, 5 parts of nano-silicon sheets, 3 parts of lubricant (zinc stearate), 0.5 parts of antioxidant (pentaerythritol tetrakis [β-(3,5-di-tert-butyl-4-hydroxyphenyl) propionate]), 1 part of flame retardant (9,10-dihydro-9-oxa-10-phosphaphenanthrene 10-oxide), and 3 parts of inorganic reinforcing filler (glass fiber);
step 2: stirring and mixing the wood fiber, the nano-silicon sheets, the lubricant (zinc stearate), the antioxidant (pentaerythritol tetrakis [β-(3,5-di-tert-butyl-4-hydroxyphenyl) propionate]), the flame retardant (9,10-dihydro-9-oxa-10-phosphaphenanthrene 10-oxide), and the inorganic reinforcing filler (glass fiber) at a speed of 150 r/min for 30 min to obtain a mixed material;
step 3: adding the high-density polyethylene into the mixed material, mixing uniformly at a speed of 150 r/min, then performing melt blending at a temperature of 170° C., and performing extrusion granulation to obtain composite particles;
step 4: extruding the composite particles in a molten state through an extruder, and performing calendering molding to obtain the antibacterial and antiviral home decoration board releasing negative oxygen ions,
wherein a barrel temperature of the extruder is 170° C., and a die head temperature is 190° C.

### Test Example

Property tests are conducted on the home decoration boards prepared in the above embodiments and comparative examples:
(1) Antiviral property: The antiviral activities of the home decoration boards prepared in Embodiments 1-6 and Comparative Examples 1-4 are measured with reference to the standard ISO 21702-2019. Test results are shown in Table 1:

TABLE 1

| | | | | | | | | Compar- | Compar- | Compar- | Compar- |
|---|---|---|---|---|---|---|---|---|---|---|---|
| | | Em- | Em- | Em- | Em- | Em- | Em- | ative | ative | ative | ative |
| | | bodi- | bodi- | bodi- | bodi- | bodi- | bodi- | Exam- | Exam- | Exam | Exam |
| | | ment 1 | ment 2 | ment 3 | ment 4 | ment 5 | ment 6 | ple 1 | ple 2 | ple 3 | ple 4 |
| Anti | Influenza A virus | 99.98 | 99.99 | 99.98 | 99.99 | 99.99 | 99.99 | 78.57 | 99.98 | 99.97 | 99.81 |
| viral | A/PR/8/34/H1N1 | | | | | | | | | | |
| activity | Host: MDCK cells | | | | | | | | | | |
| rate | Enterovirus EV71 | 99.88 | 99.94 | 99.90 | 99.92 | 99.92 | 99.93 | 72.33 | 99.87 | 99.88 | 99.56 |
| (%) | Host: Vero cells | | | | | | | | | | |

(2) Antibacterial property: The antibacterial rates of the home decoration boards prepared in Embodiments 1-6 and Comparative Examples 1-4 are measured with reference to the standard QB/T4371-2012 “Appendix B Film Attaching Method of Evaluation for Antibacterial property of Furniture” for an action time of 24 h. Test results are shown in Table 2:

TABLE 2

| | | | | | | | | Compara- | Compara- | Compara- | Compara- |
|---|---|---|---|---|---|---|---|---|---|---|---|
| | | Em- | Em- | Em- | Em- | Em- | Em- | tive | tive | tive | tive |
| | | bodi- | bodi- | bodi- | bodi- | bodi- | bodi- | Exam- | Exam- | Exam- | Exam- |
| | | ment 1 | ment 2 | ment 3 | ment 4 | ment 5 | ment 6 | ple 1 | ple 2 | ple 3 | ple 4 |
| Anti | Escherichia coli | >99 | >99 | >99 | >99 | >99 | >99 | 81.2 | >99 | >99 | 98.85 |
| bacterial | Staphylococcus | >99 | >99 | >99 | >99 | >99 | >99 | 80.8 | >99 | >99 | 98.80 |
| rate | aureus | | | | | | | | | | |
| (%) | Candida | >99 | >99 | >99 | >99 | >99 | >99 | 81.1 | >99 | >99 | 98.69 |
| | albicans | | | | | | | | | | |

(3) Negative oxygen ion release property: The negative air ion concentrations of the home decoration boards prepared in Embodiments 1-6 and Comparative Examples 1-4 are measured with reference to the standard JC/T2110-2012 “Indoor Air Ion Concentration Test Method”. Test results are shown in Table 3:

TABLE 3

| | | | | | | | Compara- | Compara- | Compara- | Compara- |
|---|---|---|---|---|---|---|---|---|---|---|
| | Em- | Em- | Em- | Em- | Em- | Em- | tive | tive | tive | tive |
| | bodi- | bodi- | bodi- | bodi- | bodi- | bodi- | Exam- | Exam- | Exam- | Exam- |
| | ment 1 | ment 2 | ment 3 | ment 4 | ment 5 | ment 6 | ple 1 | ple 2 | ple 3 | ple 4 |
| Average value of | 2098 | 2118 | 2105 | 2109 | 2111 | 2115 | 945 | 2096 | 2098 | 2087 |
| concentration of | | | | | | | | | | |
| negative air ions | | | | | | | | | | |
| (ions/cm³) | | | | | | | | | | |

It can be seen from Table 1, Table 2, and Table 3 that the home decoration boards prepared in the present application have the good antiviral property and antibacterial property and can release a large number of negative oxygen ions. The nano-silicon sheets are selected from natural inorganic bentonite or attapulgite, which are detached layer by layer into sheets using a delamination technology, and are rich in negative charges, the negative charges exposed to the outside will form a strong adsorption force such that positively charged bacteria, viruses, or odors are adsorbed to their surfaces, and the adoption of the mechanism of using the natural silicon sheets to adsorb harmful molecules and resist adhesion can achieve the special effects of environmental purification, bacterial resistance and mildew prevention, dust removal and deodorization, and ultraviolet resistance, and can effectively prevent the breeding of germs and purify environmental quality. Compared with Embodiment 1, in Comparative Example 1, without the addition of the nano-silicon sheets, the antiviral property, the antibacterial property, and the ability to release negative oxygen ions are all significantly decreased; in Comparative Example 2, without the addition of the flame retardant (9,10-dihydro-9-oxa-10-phosphaphenanthrene 10-oxide), the antiviral property, the antibacterial property, and the ability to release negative oxygen ions are not affected; in Comparative Example 3, without the addition of the inorganic reinforcing filler (glass fiber), the antiviral property, the antibacterial property, and the ability to release negative oxygen ions are not affected; in Comparative Example 4, without the addition of the coupling agent (γ-(methacryloyloxy) propyltrimethoxysilane), the dispersibility of the nano-silicon sheets is decreased, and the antiviral property, the antibacterial property, and the ability to release negative oxygen ions are all slightly decreased.
(4) Flame retardant property: The limiting oxygen indexes of the home decoration boards prepared in Embodiments 1-6 and Comparative Examples 1-4 are measured with reference to the standard GB/T2406.1-2008 “Plastics-Determination of Burning Behavior by Oxygen Index—Part 1: Guidance”. Test results are shown in Table 4:

TABLE 4

| | | | | | | | Compara- | Compara- | Compara- | Compara- |
|---|---|---|---|---|---|---|---|---|---|---|
| | Em- | Em- | Em- | Em- | Em- | Em- | tive | tive | tive | tive |
| | bodi- | bodi- | bodi- | bodi- | bodi- | bodi- | Exam- | Exam- | Exam- | Exam- |
| | ment 1 | ment 2 | ment 3 | ment 4 | ment 5 | ment 6 | ple 1 | ple 2 | ple 3 | ple 4 |
| Limiting oxygen | 27.8 | 28.5 | 28.0 | 28.1 | 28.3 | 28.5 | 27.6 | 25.7 | 27.8 | 27.5 |
| index (%) | | | | | | | | | | |

It can be seen from Table 4 that the home decoration boards prepared in the present application have the good flame retardant property. By the addition of the flame retardant, the flame retardant property of the home decoration boards can be effectively improved. Compared with Embodiment 1, in Comparative Example 1, without the addition of the nano-silicon sheets, the antiviral property, the antibacterial property, and the ability to release negative oxygen ions are mainly affected, and the flame retardant property is not obviously affected; in Comparative Example 2, without the addition of the flame retardant (9,10-dihydro-9-oxa-10-phosphaphenanthrene 10-oxide), the flame retardant property is obviously decreased; in Comparative Example 3, without the addition of the inorganic reinforcing filler (glass fiber), the flame retardant property is not obviously affected; in Comparative Example 4, without the addition of the coupling agent (γ-(methacryloyloxy) propyltrimethoxysilane), the flame retardant property is also not obviously affected.
(5) Mechanical property: The tensile strength of the home decoration boards prepared in Embodiments 1-6 and Comparative Examples 1-4 is measured with reference to the standard GB/T1040.1-2006 “Plastics-Determination of Tensile Properties-Part 1: General Principles”. Test results are shown in Table 5:

TABLE 5

| | | | | | | | Compara- | Compara- | Compara- | Compara- |
|---|---|---|---|---|---|---|---|---|---|---|
| | Em- | Em- | Em- | Em- | Em- | Em- | tive | tive | tive | tive |
| | bodi- | bodi- | bodi- | bodi- | bodi- | bodi- | Exam- | Exam- | Exam- | Exam- |
| | ment 1 | ment 2 | ment 3 | ment 4 | ment 5 | ment 6 | ple 1 | ple 2 | ple 3 | ple 4 |
| Tensile strength | 82.3 | 83.6 | 82.5 | 82.9 | 83.1 | 83.3 | 80.4 | 82.2 | 78.8 | 81.7 |
| (MPa) | | | | | | | | | | |

It can be seen from Table 5 that the home decoration boards prepared in the present application have the good mechanical property. By the addition of the inorganic reinforcing filler, the mechanical property of the home decoration boards can be effectively improved. Compared with Embodiment 1, in Comparative Example 1, without the addition of the nano-silicon sheets, since the nano-silicon sheets as an inorganic material can help improve the mechanical property of the board, the tensile strength is decreased; in Comparative Example 2, without the addition of the flame retardant (9,10-dihydro-9-oxa-10-phosphaphenanthrene 10-oxide), the mechanical property is not obviously affected; in Comparative Example 3, without the addition of the inorganic reinforcing filler (glass fiber), the mechanical property is obviously decreased; in Comparative Example 4, without the addition of the coupling agent (γ-(methacryloyloxy) propyltrimethoxysilane), the dispersibility of the inorganic reinforcing filler is decreased, and the mechanical property is decreased to some extent.

Although the embodiments of the present application have been shown and described, for those of ordinary skill in the art, it can be understood that various changes, modifications, substitutions, and variations can be made to these embodiments without departing from the principles and spirit of the present application, and the scope of the present application is defined by the appended claims and their equivalents.

What is claimed is:

1. A preparation method of an antibacterial and antiviral home decoration board releasing negative oxygen ions, comprising the following steps:
step 1: weighing dried raw materials: polyolefin resin, wood fiber, nano-silicon sheets, a lubricant, an antioxidant, a flame retardant, a coupling agent, and inorganic reinforcing filler;
step 2: stirring and mixing the wood fiber, the nano-silicon sheets, the lubricant, the antioxidant, the flame retardant, the coupling agent, and the inorganic reinforcing filler to obtain a mixed material;
step 3: adding the polyolefin resin into the mixed material, mixing uniformly, and performing melt blending and extrusion granulation to obtain composite particles;
step 4: extruding the composite particles in a molten state through an extruder, and performing calendering molding to obtain the antibacterial and antiviral home decoration board releasing negative oxygen ions.

2. The preparation method of an antibacterial and antiviral home decoration board releasing negative oxygen ions according to claim 1, wherein in the step 1, the dried raw materials comprise, in parts by weight, 20-30 parts of the polyolefin resin, 35-50 parts of the wood fiber, 5-10 parts of the nano-silicon sheets, 3-5 parts of the lubricant, 0.5-1 part of the antioxidant, 1-3 parts of the flame retardant, 0.5-1.5 parts of the coupling agent, and 3-5 parts of the inorganic reinforcing filler.

3. The preparation method of an antibacterial and antiviral home decoration board releasing negative oxygen ions according to claim 1, wherein the polyolefin resin comprises polyethylene.

4. The preparation method of an antibacterial and antiviral home decoration board releasing negative oxygen ions according to claim 3, wherein the polyethylene comprises high-density polyethylene.

5. The preparation method of an antibacterial and antiviral home decoration board releasing negative oxygen ions according to claim 1, wherein the lubricant comprises stearate, the antioxidant comprises pentaerythritol tetrakis [β-(3,5-di-tert-butyl-4-hydroxyphenyl) propionate], the flame retardant comprises 9,10-dihydro-9-oxa-10-phosphaphenanthrene 10-oxide, the coupling agent comprises a silane coupling agent, and the inorganic reinforcing filler comprises glass fiber.

6. The preparation method of an antibacterial and antiviral home decoration board releasing negative oxygen ions according to claim 5, wherein the stearate comprises any one of zinc stearate and calcium stearate, and the silane coupling agent comprises any one of γ-(methacryloyloxy) propyltrimethoxysilane, γ-aminopropyltriethoxysilane, and γ-glycidoxypropyltrimethoxysilane.

7. The preparation method of an antibacterial and antiviral home decoration board releasing negative oxygen ions according to claim 1, wherein in the step 3, a temperature of melt blending is 170-190° C.

8. The preparation method of an antibacterial and antiviral home decoration board releasing negative oxygen ions according to claim 1, wherein in the step 4, a barrel temperature of the extruder is 170-190° C., and a die head temperature is 190-200° C.

9. An antibacterial and antiviral home decoration board releasing negative oxygen ions prepared by the preparation method of an antibacterial and antiviral home decoration board releasing negative oxygen ions according to claim 1.

10. Antibacterial and antiviral furniture releasing negative oxygen ions prepared from the antibacterial and antiviral home decoration board releasing negative oxygen ions according to claim 9.
